(19) United States
(12) Patent Application Publication
(10) Pub. No.: US 2019/0080381 A1
(43) Pub. Date: Mar. 14, 2019

(54) EVENT CENTRIC GROUP NEGOTIATIONS

(71) Applicants: John Innes, Plano, TX (US); John Truitt, Plano, TX (US)

(72) Inventors: John Innes, Plano, TX (US); John Truitt, Plano, TX (US)

(21) Appl. No.: 16/125,254

(22) Filed: Sep. 7, 2018

Related U.S. Application Data
(60) Provisional application No. 62/556,299, filed on Sep. 8, 2017.

(51) Int. Cl. G06Q 30/06; G06Q 10/02; G06Q 50/00

(52) U.S. Cl. CPC G06Q 30/0617; G06Q 50/01; G06Q 30/0605; G06Q 10/02

(57) ABSTRACT

A system and method of inventory management through event centric group negotiations comprising, receiving via at least one electronic device an event guest list to populate and define characteristics of the event centric group, receiving from at least one secondary electronic device an available inventory of an event forum, wherein the at least one secondary electronic device is at least one of the at least one electronic device and another electronic device and receiving from at least one tertiary electronic device a proposal based on the available inventory of the event forum and the defined characteristics of the event centric group, wherein the at least one tertiary electronic device is at least one of the at least one electronic device and the another electronic device.

### RELATED APPLICATIONS

This application is related to U.S. Provisional Application Nos. 62/556,299 (filed on Sep. 8, 2017), which is incorporated by reference herein for all purposes. The present application hereby claims priority under 35 U.S.C. §119(e) to U.S. Provisional Application Nos. 62/556,299.

### TECHNOLOGY

The present disclosure relates generally to systems and methods of creating purchasing groups. More particularly, various embodiments of the present disclosure relates to creating purchasing groups having event centric group negotiations.

### BRIEF DESCRIPTION OF THE DRAWINGS

An embodiment of the instant disclosure is illustrated by way of example, and not in way by limitation, in the figures of the accompanying drawings and in which like reference numerals refer to similar elements and in which:

FIG. 1 depicts a first example computer hardware embodiment;

FIG. 2 depicts a group event formation in accordance with an embodiment of the disclosure;

FIG. 3 depicts a group formation in accordance with an embodiment of the disclosure;

FIG. 4 depicts Event Host processing in accordance with an embodiment of the disclosure;

FIG. 5 depicts payment processing in accordance with an embodiment of the disclosure; and

FIG. 6 depicts a second method in accordance with an embodiment of the disclosure.

### SUMMARY

In a first aspect of the disclosure, a method of inventory management through event centric group negotiations is set forth. The method of inventory management through event centric group negotiations comprising, receiving via at least one electronic device an event guest list to populate and define characteristics of the event centric group, receiving from ideally at least one secondary electronic device an available inventory of an event forum, wherein the at least one secondary electronic device is at least one of the at least one electronic device and another electronic device and receiving from at least one tertiary electronic device a proposal based on the available inventory of the event forum and the defined characteristics of the event centric group, wherein the at least one tertiary electronic device is at least one of the at least one electronic device and the another electronic device.

In a second aspect of the disclosure, a method of inventory management through event centric group negotiations is set forth. The method of inventory management through event centric group negotiations comprising, receiving via at least one electronic device an event guest list to populate and define characteristics of the event centric group, receiving from at least one secondary electronic device an event forum, wherein the at least one secondary electronic device is at least one of the at least one electronic device and another electronic device, forming from at least one tertiary electronic device a group event based on the event forum and the event guest list, receiving from at least one quaternary electronic device an available inventory of an event forum, wherein the at least one quaternary electronic device is at least one of the at least one electronic device and another electronic device and receiving from at least one quinary electronic device a proposal based on the available inventory of the event forum and the defined characteristics of the event centric group, wherein the at least one quinary electronic device is at least one of the at least one electronic device and the another electronic device.

In a third aspect of the disclosure, a method of inventory management through event centric group negotiations is set forth. The method of inventory management through event centric group negotiations comprising, receiving via at least one electronic device an event guest list to populate and define characteristics of the event centric group, receiving from at least one secondary electronic device an event forum, wherein the at least one secondary electronic device is at least one of the at least one electronic device and another electronic device, forming via at least one tertiary electronic device a group event based on the event guest list and the event forum, wherein the at least one tertiary electronic device is at least one of the at least one electronic device and another electronic device, receiving from at least one quaternary electronic device a proposal based on the available inventory of the event forum and the defined characteristics of the event centric group, wherein the at least one quaternary electronic device is at least one of the at least one electronic device and another electronic device, modifying via at least one quinary electronic device the group event based on the proposal, wherein the at least one quinary electronic device is at least one of the at least one electronic device and another electronic device and receiving from at least one senary electronic device a secondary proposal based on the available inventory of the event forum and a social profile of the event guest list, wherein the at least one senary electronic device is at least one of the at least one electronic device and another electronic device.

In a fourth aspect of the disclosure, a method of inventory management through event centric group negotiations is set forth. The method of inventory management through event centric group negotiations comprising, receiving via at least one electronic device an event guest list to populate and define characteristics of the event centric group, receiving from at least one secondary electronic device an available inventory of an event forum, wherein the at least one secondary electronic device is at least one of the at least one electronic device and another electronic device, receiving from at least one tertiary electronic device a proposal based on the available inventory of the event forum and the defined characteristics of the event centric group, wherein the at least one tertiary electronic device is at least one of the at least one electronic device and another electronic device and requesting via at least one quaternary electronic device an assignment of the available inventory to the event centric group, wherein the at least one quaternary electronic device is at least one of the at least one electronic device and another electronic device.

In a fifth aspect of the disclosure, a method of inventory management through event centric group negotiations is set forth. The method of inventory management through event centric group negotiations comprising, receiving via at least one electronic device an event guest list to populate and define characteristics of the event centric group, receiving from at least one secondary electronic device an available inventory of an event forum, wherein the at least one secondary electronic device is at least one of the at least one electronic device and another electronic device, forming via at least one tertiary electronic device a group event based on the event forum and the event guest list, wherein the at least one tertiary electronic device is at least one of the at least one electronic device and another electronic device, rejecting via at least one quaternary electronic device the group event if the event guest list is less than a predetermined threshold, wherein the at least one quaternary electronic device is at least one of the at least one electronic device and another electronic device and requesting via at least one quinary electronic device an Event Host acceptance of the group event, wherein the at least one quinary electronic device is at least one of the at least one electronic device and another electronic device.

### DESCRIPTION OF EXAMPLE EMBODIMENTS

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

It will be understood that well known processes and components have not been described in detail and have been omitted for brevity. Although specific steps, structures and materials may have been described, the present disclosure may not be limited to these specifics, and others may be substituted as it is well understood by those skilled in the art, and various steps may not necessarily be performed in the sequences shown.

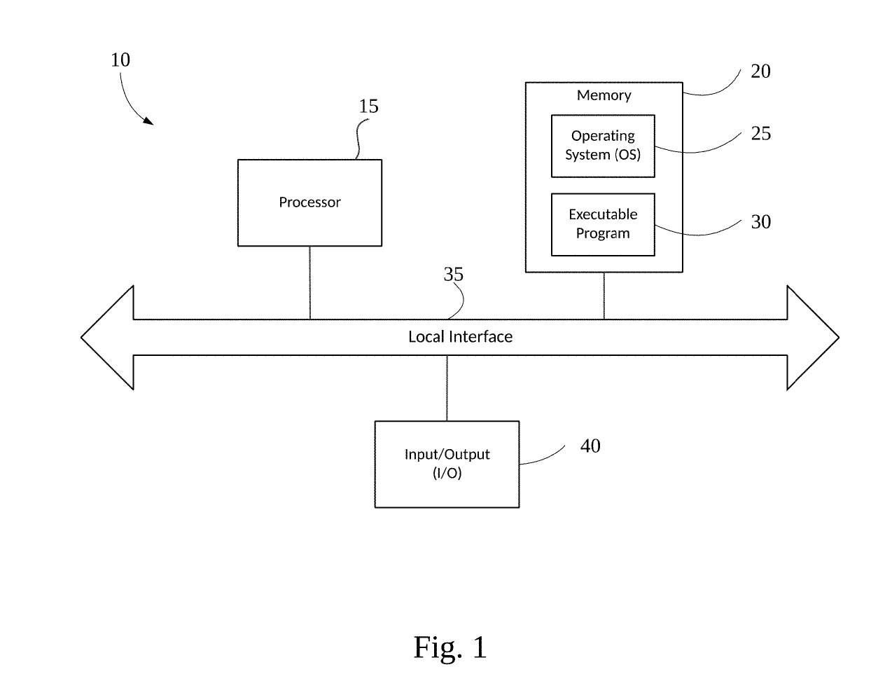

FIG. 1 depicts a first exemplary embodiment of target hardware for implementation of an embodiment of the present disclosure.

FIG. 1 is an exemplary embodiment of a target hardware (10) (e.g., a computer system) for implementing one of the embodiments of FIG. 1. This target hardware comprises a processor (15), a memory bank (20), a local interface bus (35) and one or more Input/Output devices (40). The processor may execute one or more instructions related to the implementation of FIG. 1, and as provided by the Operating System (25) based on some executable program (30) stored in the memory (20). These instructions are carried to the processor (15) via the local interface (35) and as dictated by some data interface protocol specific to the local interface and the processor (15). It should be noted that the local interface (35) is a symbolic representation of several elements such as controllers, buffers (caches), drivers, repeaters and receivers that are generally directed at providing address, control, and/or data connections between multiple elements of a processor based system. In some embodiments the processor (15) may be fitted with some local memory (cache) where it may store some of the instructions to be performed for some added execution speed. Execution of the instructions by the processor may require usage of some input/output device (40), such as inputting data from a file stored on a hard disk, inputting commands from a keyboard, inputting data and/or commands from a touchscreen, outputting data to a display, or outputting data to a Universal Serial Bus (USB) flash drive. In some embodiments, the operating system (25) facilitates these tasks by being the central element to gathering the various data and instructions required for the execution of the program and provide these to the microprocessor. In some embodiments the operating system may not exist, and tasks are under direct control of the processor (15), although the basic architecture of the target hardware device (10) will remain the same as depicted in FIG. 1. In some embodiments a plurality of processors may be used in a parallel configuration for added execution speed. In such a case, the executable program may be specifically tailored to a parallel execution. Also, in some embodiments the processor (15) may execute part of the implementation of FIG. 1, and some other part may be implemented using dedicated hardware/firmware placed at an Input/Output location accessible by the target hardware (10) via local interface (35). The target hardware (10) may include a plurality of executable programs (30), which may run independently or in combination with one another.

### DEFINITIONS

Event Host—a venue or event, or a representative for a venue or event. The Event Host is responsible for responding to group requests and managing the event listing and availability.

Group Leader—the person creating and managing the group request including responding to Event Host proposals and other communications.

Group Member—an invitee by the Group Leader.

Group Event Request—the formal request for attending an event or visiting a venue for a group.

### OVERVIEW

The method provides an event driven group formation process to manage information flow, distribute payment risks and provide a framework for group negotiations with an Event Host to facilitate venue inventory management of tickets and capacity. A process for forming a group centered on published event descriptions forms a group event request. Group Event Requests may be utilized as a means to manage and sell inventory. The Event Host proposal and acceptance process enables the management of constrained inventory and the promotion of additional or upgraded services offered back to a group in response to a Group Event Request or unsolicited. Currently, group based outings require a central coordinator of the outing and a central coordinator of an event interacting on behalf of their respective parties. In the current situation, the outing central coordinator assumes financial risk for the outing and the central host coordinator receives limited or no information of the participants of the outing.

Both the central coordinator of the outing, i.e. the Group Leader, and the central coordinator of the event, i.e. the Event Host, are at a disadvantage due to working with limited information and communications. The method of the instant disclosure may provide a means to distribute the financial risk assumed by the Group Leader and increase the information provided by individuals in the group to the Event Host, so that the Event Host may better manage the scarce resource of available inventory, provide more targeted services, allow more rapid flow of information, and real time updating of available inventory for Group Leaders and other Event Host administrators. Additionally, the Event Host may be able to better manage the event forum ticket inventory to the mutual benefit of the Event Host and the group. The Event Host is the counterparty to the Group Leader and is the ticketing office for the venue site that is hosting the event. The event is managed from the Event Host side.

Currently there is little or no communication between the group and the Event Host, or knowledge of the likes and dislikes of the invitees or members forming the group for the Event Host as communication occurs only between the Event Host and the Group Leader. The Event Host does not know beforehand who is coming to the event or any information pertaining to the members forming the group. This member information may have market value for the Event Host. Currently, payback risk resides with the Group Leader to manage the financial transactions for the group. The present system disclosure facilitates information flow about attendees to an event for an Event Host and mitigates the financial risk to the Group Leader.

As things are presently and due to the limited coordination across groups and between groups and the Event Host, if individuals in a group purchase tickets, the group may be scattered across different sections absent the assumption of substantial financial risk by the Group Leader by purchasing the tickets. Organizers don't know who is attending; their affiliations or how many people are going to an event, as limited coordination occurs between the Group Member and the Event Host.

In one exemplary method of the instant disclosure, there are several interlinking elements, group formation, group and Group Member event history including proposal acceptance, rejection history, optional intelligent proposals for negotiation by the Event Host based on Group Member information and a preauthorization by the Group Members, Group Member requests for additional services offered by the Event Host, affiliated Event Host partners, and third party service providers, for example dining preferences or transportation.

One exemplary method of the present disclosure would be for ticketing for sporting events, but it is envisioned that the system and methodology may be used with any ticketed entertainment event or travel venue where attendance inventory is constrained and possibly as an ad hoc event formation hosted by a private party or individual.

### Forming a Group Event

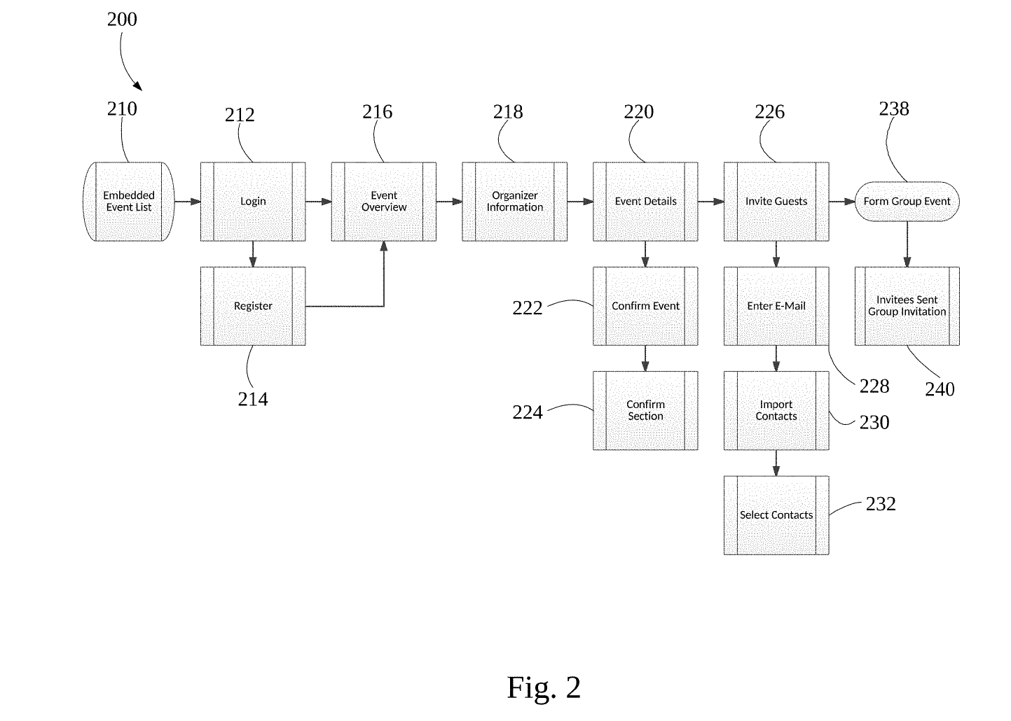

FIG. 2 depicts one example of one method of forming a group event 200. An embedded event list 210 is presented and a login 212 or registration 214 is performed, and an event overview 216 is presented. Organizer information 218 is input in which the name, email address, phone number and commonly known name or function is input. The event details are shown 220, to confirm the event 222 and the seating section 224. Guests are invited 226 based on emails or communications preferences 228 and contacts may be imported 230 from which guests are selected 232. A group event is formed 238 and invitees are sent a group invitation 240. Although shown and described that certain steps occur after other steps herein, it should be clear that the steps may occur concurrently, out of the order shown without departing from the invention which should only be limited to the claims.

The steps in forming a group, group overview, organizer information, event and section selection, invitation management and acceptance need not be sequential, or be input by one person or on the same device.

The system has the ability to filter based, for example, on the number of people expected to come, date range, day of week, seating, price point, category, search term and the like. The method may display an Event Host's scheduled events, pick the events, and display group sections that are available. Information about inventory availability may come from system databases or external data sources integrated into the software.

The Group Leader may select an event and form a group creating what is called a group event. The Group Leader may select an initial event, a section or where the group may like to sit, time and place and who to invite. The junction of the event and the group is the formation of a group event. The Group Leader may indicate additional requests as stated above.

A Group Leader ideally, may declare a minimum group size to be met for a group-event to be recognized fully formed and a request is sent to an Event Host. This option ensures an optimal group size for Event Host inventory management and facilitates group formation by ensuring Group Members that there will be a sufficient group size to meet their requirements.

An Event Host ideally, may declare a minimum group event size, at their discretion. Minimums may be set on the primary group event and/or each individual add-on service. If an event minimum is not met, a group-event does not fully form and the event-host is not shown the request. Minimums for add-on services may be mutually exclusive to each other. Event host may however, optionally be able to view all the requests where an event minimum was not met or where they where they were not met by a certain number or percentage.

A Group Leader ideally, may declare a maximum group size. If a group reaches a maximum size, no more invitations may be honored, the group is recognizes as fully formed, and the request notification is sent to the Event Host.

An Event Host ideally, may declare a maximum group event size, at their discretion. Maximums may be set on the primary group event and/or each individual add on service. If an event maximum is met, a group-event fully forms and the event-host is notified of a request. Maximums for add-on services may be mutually exclusive to each other.

If group size limitations are within tolerance, a Group Leader may recognize a group-event as fully-formed, stopping any future invitations from being accepted, and sending a request notification to the Event Host.

### Invitations

Invitations in the form of electronic communications such as email, text, internal application notifications, etc. are sent out to each Group Member to join the group, and those members respond to the communications to accept or reject.

A Group Member may state for example “I am bringing 8 people”.

An attending Group Member will provide a form of preauthorized payment with a not to exceed value. A variance may be incorporated to facilitate group formation through the proposal process by allowing an increased preauthorized value.

An attending Group Member ideally, may elect to separately attend or not attend group-based add-on services, as defined above, for example, an event function or concessions package in which the Event Host requires a minimum number of Group Members to attend.

An attending Group Member ideally, may elect to separately attend individual add-on services, as defined above, for example a meet-and-greet in which the tickets are provided on an individual basis.

Invitees ideally, may also be allowed access to the other members of the group and may be invited by email address, phone number, and other forms of electronic contact. Forms of contact may be imported from contacts lists made available on electronic devices and online sources such social media sites.

As each Group Member accepts or rejects the invitation, each one declares the number of guests in their party, and selects from optional add-on services, this information is made visible to the rest of the group and the Event Host through summary pages on the site and/or application.

There may be a tolerance imposed by the Event Host and/or Group Leader that is met for a group-event to be considered fully formed. If the criteria are met, the system will allow the group to fully form. As stated above, once a group-event is within tolerances, the group-event may be formed by the expiration of the formation-timer or may be forcefully formed by the Group Leader.

Additionally, anyone within the group can see who is coming. The method allows for managing communications to facilitate information flow. The communications may comprise email, text, message boards, voice communications, and the like.

### Group Member Statistics

For purposes of offering additional services and upgrades the Event Host may look at statistics of the Group Members to build one or more proposals for the Group Leader which is based on the initial group event request.

The Group Member statistics ideally, may be collected and may give insight to the Event Host on the common traits of people are interested in these types of events. This allows targeting in the future of other events that individuals with these characteristics may be interested in. It allows them to determine the type of people coming to the event and the kind of events that Group Members may like to go to.

The Group Member statistics may provide a wealth of information to the Event Host to also help with facilitating the event so that it is enjoyed.

### Payment Preauthorization

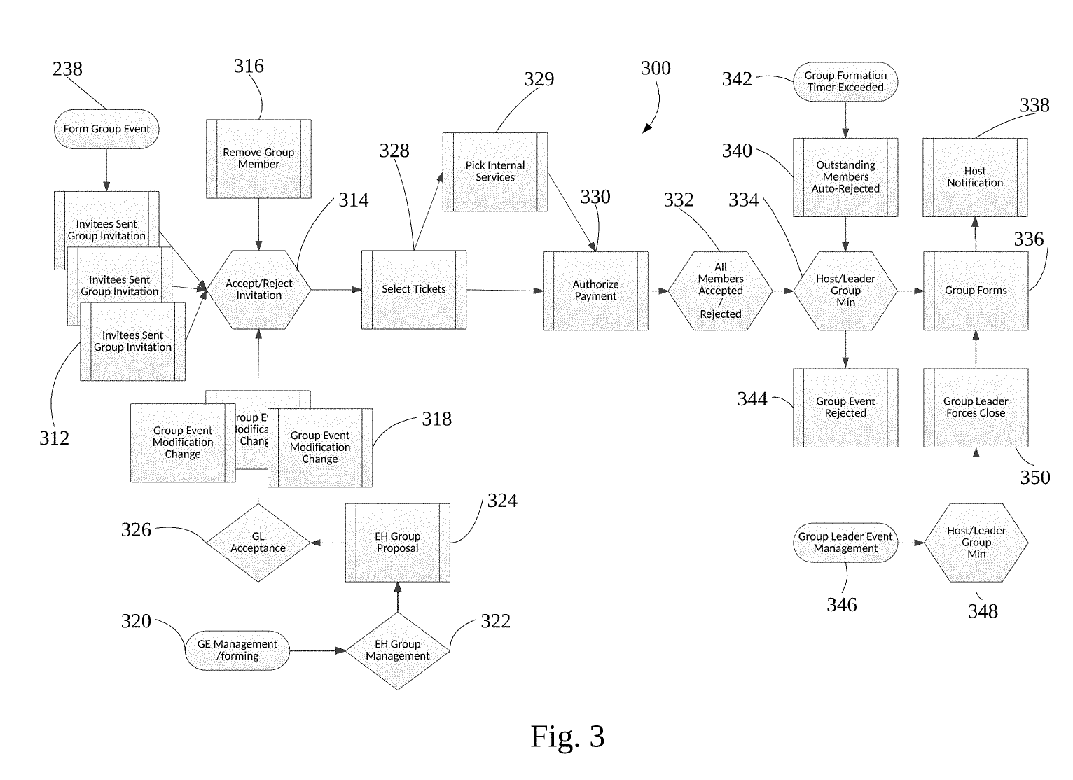

FIG. 3 depicts one exemplary method to perform the method between group event formation and host notification which comprises payment preauthorization. The group event formed 238 in FIG. 2 is extended in part through host notification. Invitees are sent a group invitation 312 and each individual may accept or reject the invitation 314 and Group Members may be removed 316.

Group Events are described as forming until certain group attendance requirements are met and a group formation event occurs such as a count-down timer expires or the Group Leader closes enrollment by forcefully forming the group, and a group-event is fully-formed or declined. If a group-event transitions into a fully-formed status, a notification is sent to the Event Host.

The Event Host ideally, may accept the original request as is and assign seats or the Event Host may offer one or more proposals 414. Proposals may suggest different seats, upgraded seating, and other options such as add-on services.

Event Host management 322 ideally, may submit Event Host group proposals 324 which the Group Leader may accept 326. The group event may be modified or changed 318 and submitted for acceptance or rejection 314. Either before, concurrently, or after the proposal process, individual Group Members select tickets 328. Internal services may be selected 329 and pre-authorization of payment may be made 330. Members may accept or reject a proposal 332 and a group minimum size is checked 334 and if the minimum size is not met the group event is rejected 344. A check may be made for the group formation timer 342, if it is exceeded outstanding invitees may be auto-rejected 340. Group leader event management may comprise input 346, where a host and or leader group minimum is not met 348, the Group Leader may force a closure 350 of the group event. If the minimums and pre-authorizations are met, the group may be formed 336, and a host notification 338 may be sent. Although shown and described that certain steps occur after other steps herein, it should be clear that the steps may occur concurrently, out of the order shown without departing from the invention which should only be limited to the claims.

If an accepted proposal causes the amount of pre-authorized charges to be exceeded, notifications are sent to affected Group Members who re-authorize payment and the group event reverts back to a forming status. If no re-authorization is required or once re-authorizations are complete, an accepted proposal replaces the original request and closes out outstanding proposals. The Event Host assigns tickets to the Group Members. Any request and any proposal may be declined by the Event Host or canceled by the Group Leader up to the point that tickets are assigned.

Invitations ideally, are sent out in the event a group is formed. If a Group Member accepts the invitation, he pre-authorizes a transaction up to a certain amount, utilizing some form of payment method. The pending charge is debited if the group agrees to a proposal and the Event Host accepts the group as formed. The payment is ideally contingent upon a group minimum and the Event Host acceptance of the proposal. The Event Host can update the proposal, but if it exceeds the pre-authorized amount a reauthorization is required. A Group member pending charge is debited when an Event Host assigns tickets.

Pre-authorization facilitates group formation and inventory management by limiting financial risk but also by communication price signals to help match event or venue supply and demand. Payment of a pre-authorization is based on a contingency that parties agree to a proposal, facilitating the group formation process. This creates a fully-formed event group with preauthorization to transact which allows the Event Host to manage their inventory with a group that will promptly pay.

### Intelligent Proposals

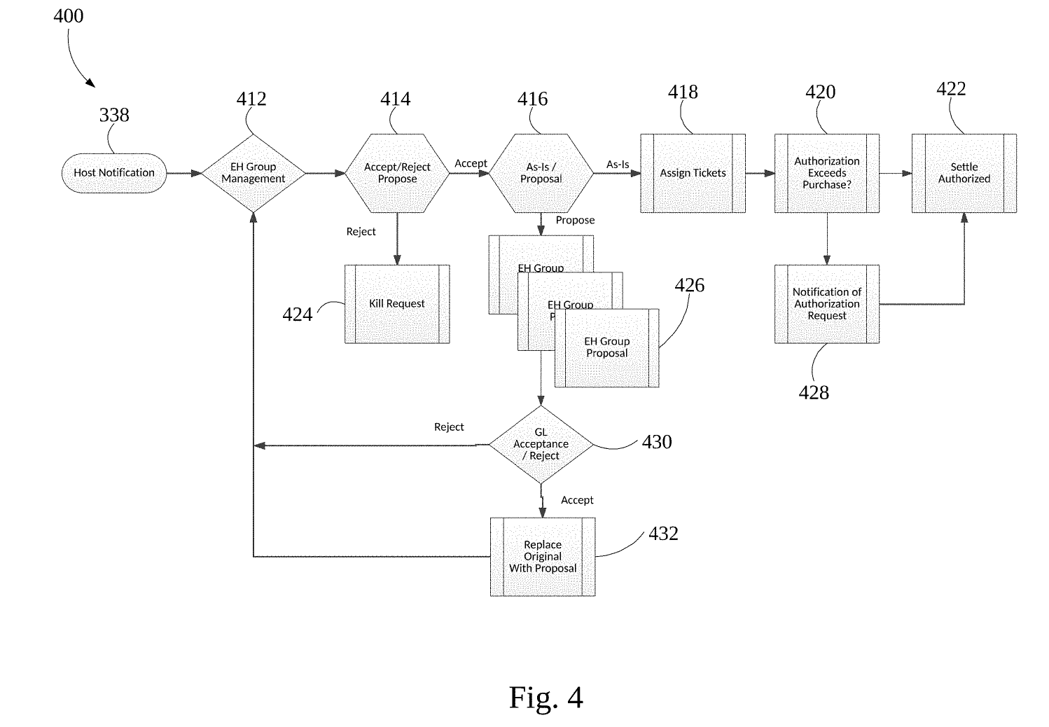

The host notification from FIG. 3 is sent 338 to Event Host if a group event is recognized as fully-formed. FIG. 4 depicts one exemplary method in which an Event Host may review group-events for their related events from a group management screen 412. From this screen an Event Host ideally, may select a specific request screen. From this screen the Event Host may accept the request as is or may build one or more proposals 426. Only the Group Leader may accept or reject a proposal 326. If a Group Leader rejects a proposal, that proposal is removed while other proposals remain valid and the original request is still in full force. If a Group Leader accepts a proposal 430 other proposals are declined and the original request is replaced with the accepted proposal 432. If the new request does not require re-authorization, the Event Host is sent a notification of the new request 338, otherwise the group is notified that re-authorization is required and the group event status reverts back to a forming state. If a request is accepted tickets are assigned 418, payments are processed. Although shown and described that certain steps occur after other steps herein, it should be clear that the steps may occur concurrently, out of the order shown without departing from the invention which should only be limited to the claims.

If a group event is recognized as fully-formed, data from the members is available to the Event Host for data analysis and intelligent proposal construction. The Event Host may show available group inventories and pricing levels. The intelligent proposal construction takes into account the individual preferences of members of the group to come up with proposals that would be most readily accepted by the group.

One or more proposals may be sent to the Group Leader for acceptance or rejection. If a proposal is accepted by the Group Leader the Event Host may begin assigning seats and the system will process the payments per the preauthorization. Or, the host may submit another proposal of alternate sections, adding internal or external services, or other more group beneficial services to be accepted or rejected by the Group Leader.

The Group Leader will either accept or reject the initial proposal or one of the follow-on proposals. The process is dynamic in which the Event Host may offer additional services for acceptance or rejection based on which section was agreed upon for ticketing.

Proposal handling for forming or formed groups allows management of inventory on the Event Host side, where fixed inventory in specific segments makes managing the inventory critical to the process. Currently, inventory management for groups is done via offline communications methods leading to difficulty managing groups and inventory. The information flow between the Group Leader and Event Host with subsequent visibility by Group Members is not currently available and hinders communication.

Proposal handling allows Event Hosts to offer a better experience to the group through different options, upgrades or downgrades.

If, for example, the initial group was for 20 tickets, if a father and son are invited, but the dad wants to bring his other two kids, the group has just grown. If others in the group have responded, the group now wants to purchase 50 tickets. If the Group Leader requested a specific number of seats in one section, the host may propose another section to sit in so that the group remains together. The system also has section size input and section size storage for comparison to the needs of event groups. The Event Host could send the Group Leader several proposals, for one section, two sections, different day, a suite or the like. For example, if section 102 costs $100 per person, but a suite is normally $150 per person, the host may propose the suite at $100 to open up the inventory for section 102. The host helps fulfill the ticket need from his inventory. Thus, this method may provide a potential solution to the bottleneck of limited inventory and a group that wants to purchase a portion of that inventory in a block seated together. In this way the method of the instant disclosure helps the Event Host manage his inventory.

Communication is sent to the Event Host, indicating the event, any section information, and services. The Event Host may send a proposal at any point in the forming process.

This process may be applicable to sporting events, tickets for arts and entertainment venues, renting vacation facilities, and other location of service with inventory constraints and dynamic group formation. The system allows the Group Leader to help the Event Host deal with one of the most difficult issues of inventory management.

### Payment Authorization

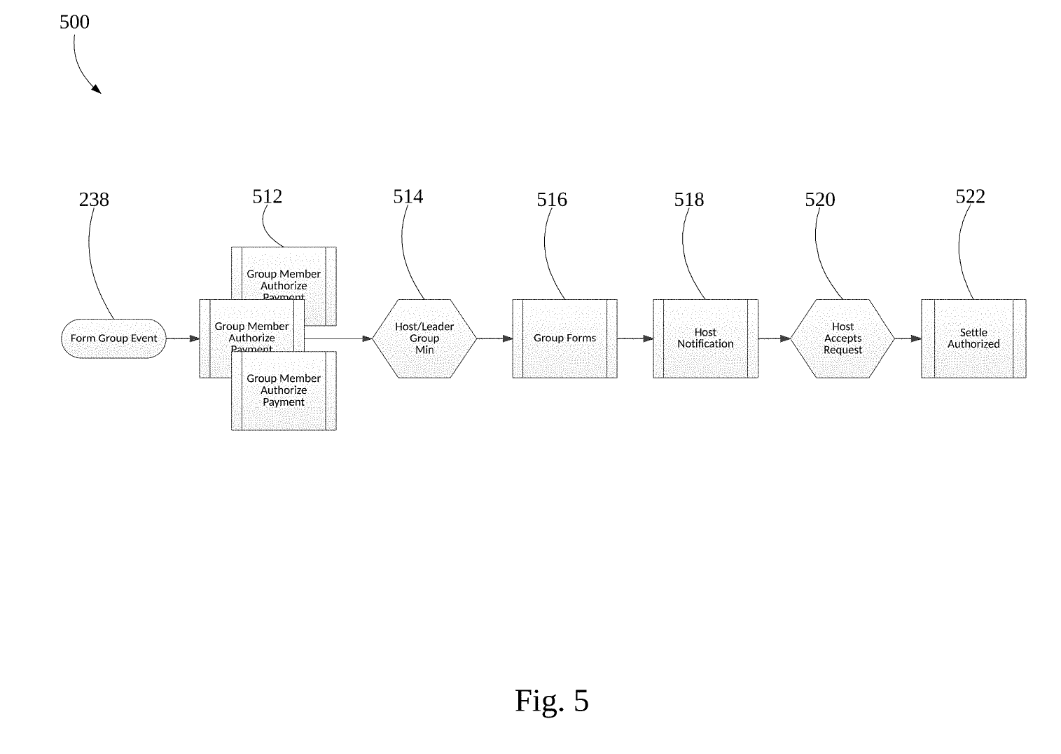

FIG. 5 depicts one exemplary method to authorize payment for the group event 500. Assuming group minimums are met 514, groups are formed 516 and a host notification is sent 518. If the host accepts the request 520 the authorization is settled 522. Although shown and described that certain steps occur after other steps herein, it should be clear that the steps may occur concurrently, out of the order shown without departing from the invention which should only be limited to the claims.

The payment handling process captures authorization for payment contingent on group minimum or other requirements and Event Host acceptance. The method eliminates payment risk for the Group Leader and Event Host. Contingent payment processing follows authorization at specific value level, upon group formation at event minimum and Event Host acceptance.

### Alternate Method

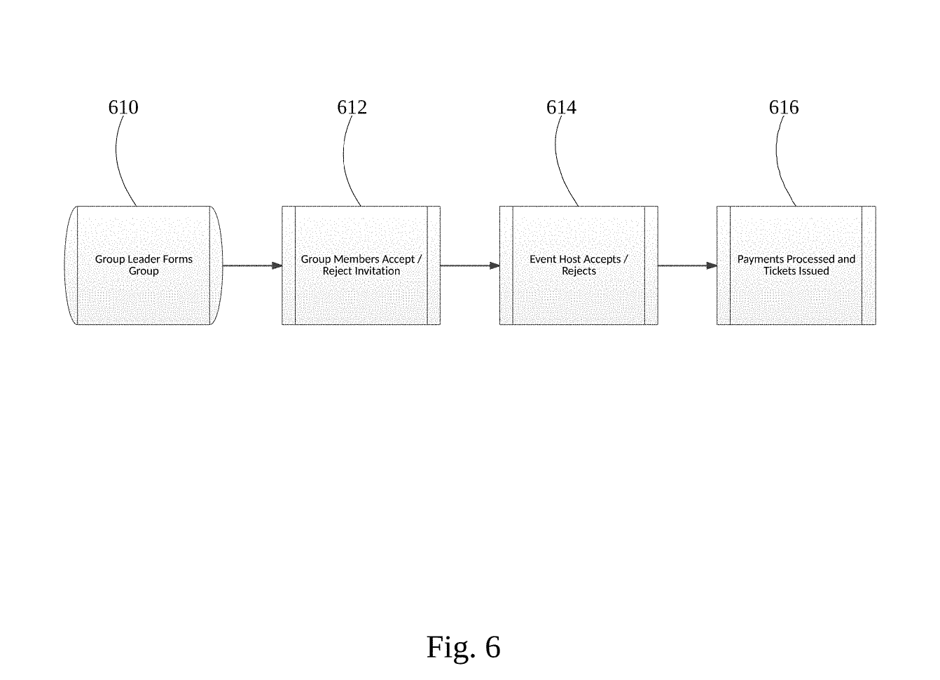

In this example shown in FIG. 6, a Group Leader would form 610 a group event and issue invitations to invitees as potential group members. Each of the invitees of the group event may either accept or reject the invitation, if they accept they become group members. A rejection may be automatic if too much time elapses before a return response is sent. If conditions that the Group Leader sets are met for the group event, the Event Host may review the group event and the number of group members who accepted the invitation. The Event Host has the option to either accept or reject the group event. If the group members and Event Host agree to terms, payment may be processes and tickets may be issued. Although shown and described that certain steps occur after other steps herein, it should be clear that the steps may occur concurrently, out of the order shown without departing from the invention which should only be limited to the claims.

### Intelligently Targeted Internal Services

An Event Host may offer one or more add-on services for an event, called an internal service.

An Event Host may have a relationship with a service provider to provide a service for the Event Host, also described as an internal service.

A Group Leader may show interest in internal services while forming a group event.

The host may also suggest adding in another item such as special attendance zones, concessions or other upselling opportunities in some other way that is amenable to multiple members of the group.

### Intelligently Targeted External Services

Services provided by any other method such as a service provider are called external services.

A Group Leader may show interest in external services by describing a category of service requested, such as dining.

Each Group Member shares some amount of associated social media information with the application. External services such as a limo picking you up at the airport may be offered in response to reviewing your social media profile and itinerary.

The targeting of external services is envisioned to be based partially on social media profiles and partially on historical choices to make purchase suggestions based on past purchases, so that the method may indicate for example “Here are five well ranked steak houses near your hotel”.

An Event Host has first options to satisfy an add-on service request. Add-on Requests not responded to by the Event Host may be responded to by the system. This response may occur in a multitude of ways which include sending requests to preferred providers of that service and pulling suggestions from social sites.

Transportation is envisioned to be coupled to the system as well as hotels and dining options based on the social media profiles of the members of the group. Hotel options based on search criteria, Group Leader may like to dine nearby, manicure, golf, etc., not knowing the area. Geolocation of the events is also envisioned.

### Equivalents, Extensions, Alternatives and Miscellaneous

The method described in the present disclosure may be implemented in hardware, software, firmware or any combination thereof. Features described as blocks, modules or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), a field programmable logic array (FPGA), a graphic processing unit (GPU) or a general purpose CPU).

Example embodiments that relate inventory management are thus described. In the foregoing specification, embodiments of the present disclosure have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of inventory management through event centric group negotiations, the method comprising:
receiving via at least one electronic device an event guest list to populate and define characteristics of the event centric group;
receiving from at least one secondary electronic device an available inventory of an event forum, wherein said at least one secondary electronic device is at least one of said at least one electronic device and another electronic device;
and receiving from at least one tertiary electronic device a proposal based on said available inventory of said event forum and the defined characteristics of the event centric group, wherein said at least one tertiary electronic device is at least one of said at least one electronic device and said another electronic device.

2. The method of claim 1 wherein said proposal is based in part on a social profile of said guest list.

3. The method of claim 1 further comprising an automated event facilitator.

4. The method of claim 3 wherein said proposal is automatically generated by said automated event facilitator based in part on a social profile of said guest list.

5. The method of claim 1 wherein said event guest list is based on a contacts list.

6. The method of claim 1 wherein said event guest list is based on commonalities of the defined characteristics of the event centric group.

7. The method of claim 1 wherein said event guest list is based on commonalities of a social profile.

8. A method of inventory management through event centric group negotiations, the method comprising:
receiving via at least one electronic device an event guest list to populate and define characteristics of the event centric group;
receiving from at least one secondary electronic device an event forum, wherein said at least one secondary electronic device is at least one of said at least one electronic device and another electronic device;
forming from at least one tertiary electronic device a group event based on said event forum and said event guest list;
receiving from at least one quaternary electronic device an available inventory of the event forum, wherein said at least one quaternary electronic device is at least one of said at least one electronic device and another electronic device; and
receiving from at least one quinary electronic device a proposal based on said available inventory of said event forum and the defined characteristics of the event centric group, wherein said at least one quinary electronic device is at least one of said at least one electronic device and said another electronic device.

9. The method of claim 8 wherein said proposal is based in part on a social profile of said guest list.

10. The method of claim 8 wherein said proposal is automatically generated by an automated event facilitator based in part on a social profile of said guest list.

11. A method of inventory management through event centric group negotiations, the method comprising:
receiving via at least one electronic device an event guest list to populate and define characteristics of the event centric group;
receiving from at least one secondary electronic device an event forum, wherein said at least one secondary electronic device is at least one of said at least one electronic device and another electronic device;
forming via at least one tertiary electronic device a group event based on said event guest list and said event forum, wherein said at least one tertiary electronic device is at least one of said at least one electronic device and another electronic device;
receiving from at least one quaternary electronic device a proposal based on said available inventory of said event forum and the defined characteristics of the event centric group, wherein said at least one quaternary electronic device is at least one of said at least one electronic device and another electronic device;
modifying via at least one quinary electronic device said group event based on said proposal, wherein said at least one quinary electronic device is at least one of said at least one electronic device and another electronic device; and
receiving from at least one senary electronic device a secondary proposal based on said available inventory of said event forum and a social profile of said event guest list, wherein said at least one senary electronic device is at least one of said at least one electronic device and another electronic device.

12. The method of claim 11 further comprising providing external services based on the social profile.

13. The method of claim 11 further comprising rejecting a member of said event guest list based on exceeding a timer threshold.

14. The method of claim 11 further comprising rejecting said proposal if said event guest list is less than a predetermined threshold.

15. A method of inventory management through event centric group negotiations, the method comprising:
receiving via at least one electronic device an event guest list to populate and define characteristics of the event centric group;
receiving from at least one secondary electronic device an available inventory of an event forum, wherein said at least one secondary electronic device is at least one of said at least one electronic device and another electronic device;
receiving from at least one tertiary electronic device a proposal based on said available inventory of said event forum and the defined characteristics of the event centric group, wherein said at least one tertiary electronic device is at least one of said at least one electronic device and another electronic device; and
requesting via at least one quaternary electronic device an assignment of said available inventory to said event centric group, wherein said at least one quaternary electronic device is at least one of said at least one electronic device and another electronic device.

16. The method of claim 15 wherein said proposal is based in part on the defined characteristics of the event centric group.

17. The method of claim 15 wherein said proposal is based in part on a social profile of said guest list.

18. The method of claim 15 wherein said proposal is automatically generated by an automated event facilitator based in part on a social profile of said guest list.

19. A method of inventory management through event centric group negotiations, the method comprising:
receiving via at least one electronic device an event guest list to populate and define characteristics of the event centric group;
receiving from at least one secondary electronic device an available inventory of an event forum, wherein said at least one secondary electronic device is at least one of said at least one electronic device and another electronic device;
forming via at least one tertiary electronic device a group event based on said event forum and said event guest list, wherein said at least one tertiary electronic device is at least one of said at least one electronic device and another electronic device;
rejecting via at least one quaternary electronic device said group event if said event guest list is less than a predetermined threshold, wherein said at least one quaternary electronic device is at least one of said at least one electronic device and another electronic device; and
requesting via at least one quinary electronic device an Event Host acceptance of said group event, wherein said at least one quinary electronic device is at least one of said at least one electronic device and another electronic device.

20. The method of claim 19 wherein a proposal is based in part on the defined characteristics of the event centric group.

21. The method of claim 19 wherein a proposal is based in part on a social profile of said guest list.

22. The method of claim 19 wherein a proposal is automatically generated by an automated event facilitator based in part on a social profile of said guest list.

23. The method of claim 19 further comprising, receiving an authorization of members of said event guest list.

24. An apparatus, comprising:
a server capable of accepting inputs from at least one electronic device, at least one at least one secondary electronic device and at least one at least one tertiary electronic device;
wherein said at least one electronic device receives an event guest list to populate and define characteristics of the event centric group;
wherein said at least one secondary electronic device receives an available inventory of an event forum, wherein said at least one secondary electronic device is at least one of said at least one electronic device and another electronic device; and
wherein said at least one tertiary electronic device receives a proposal based on said available inventory of said event forum and the defined characteristics of the event centric group, wherein said at least one tertiary electronic device is at least one of said at least one electronic device and said another electronic device.
